(19) United States
(12) Patent Application Publication
(10) Pub. No.: US 2005/0025867 A1
(43) Pub. Date: Feb. 3, 2005

(54) Processed barley food products

(76) Inventors: Nancy Ames, Manitoba (CA); Camille Rhymer, Manitoba (CA)

Correspondence Address: ADE & COMPANY, 1700-360 MAIN STREET, WINNIPEG, MB, R3C3Z3, CA

(21) Appl. No.: 10/888,502

(22) Filed: Jul. 12, 2004

(30) Foreign Application Priority Data
Jul. 11, 2003 (CA) 2,435,053

(51) Int. Cl. A23B 4/03

(52) U.S. Cl. 426/465

(57) ABSTRACT

The processing of raw barley grains to a quick cooking barley product useable as a rice substitute and a snack product is described.

### PRIOR APPLICATION INFORMATION

This application claims priority on Canadian Patent Application 2,435,053, filed Jul. 11, 2003.

### FIELD OF THE INVENTION

The present invention relates generally to the field of food products.

### BACKGROUND OF THE INVENTION

Pearled barley (also known as pot or soup barley) represents one of the few barley products currently available to the consumer despite the potential health benefits that are associated with this grain. Pot barley currently commercially available has been pearled (removal of outer seed coat) to achieve a white color and to remove some of the germ material. This means the pearled barley no longer can be considered a whole grain product and lacks some of the nutritional value associated with a whole grain barley product. The pearled barley available commercially requires a relatively long cooking period (15-45 minutes) to achieve optimum texture similar to that of long cooking rice. For consumers to fully benefit from the nutritional advantages of barley, an instant whole grain product should provide the necessary health benefits with minimum cooking time. Food manufacturers developing new products for convenience of consumers would be able to incorporate this product into prepackaged foods which require minimum input of ingredients (for example, just add to boiling water or pour boiling water on top and let stand) or time. A whole grain barley product for use as a rice replacement or as a nut replacement (snack food) containing high viscosity beta glucan would provide consumers with a more nutritious alternative for meals or snacks.

U.S. Pat. No. 5,132,133 teaches a method of micronizing whole grains to produce a crisp whole grain snack food. One of the grains listed is barley. This patent however states that the grains must be first be tempered to a moisture content of approximately 14 to 22%.

U.S. Pat. No. 4,555,409 teaches radiating cereal grains having a moisture content of about 30% with infrared radiation until partially gelatinized as a method of making masa. However, this patent does state that when barley is used it is dehulled barley.

### SUMMARY OF THE INVENTION

According to a first aspect of the invention, there is provided a method of processing barley comprising:
tempering barley grains to 26-30% moisture; and
raising internal temperature of the tempered barley to 110-162° C.

The processed barley may be air dried to about 12% moisture.

The barley grains may be low amylose barley and the barley may be processed to a quick cooking barley product. The barley may be CDC Candle.

The barley may be normal amylose barley and the barley may be processed to a barley snack product. The barley may be CDC Dawn.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a process for preparing novel whole grain barley food products, for example, a quick cooking whole barley product and a barley snack product. The process involves use of specific barley cultivars that are tempered to 26 to 30% moisture and are heated, for example, by micronization or by a combination of forced air heat and microwave energy. Micronization bears no reference to microwaves but rather uses infrared energy at wavelengths of 1.8 to 3.4 microns. Infrared energy travels at the speed of light and is converted to heat when it strikes absorbent material. The result, inter-molecular friction, brings about rapid internal heating and a rise in water vapour pressure.

Once prepared as described below, the quick cooking whole barley product can be cooked by hydrating the treated barley in at least equal volume of boiling water (typically 1:1 or 1:1.5 barley to water) for 2.5 to 5 minutes followed by a stand time of 5 or more minutes.

The barley snack product can be eaten as a snack (with or without further cooking) and could also be considered as a nut replacement wherein the barley snack product is then roasted with seasoning and then eaten as a snack or added to recipes requiring low moisture nuts.

We have tested the quick cooking whole barley product as an ingredient in side dishes as a replacement for rice or long cooking pot barley or pasta. Thus, the quick cooking whole barley product can be used in any recipe that calls for grains, for example, salads, tacos, desserts, pilafs, tabouli, risotto and the like. Furthermore, analysis has shown that the texture, preparation time and conditions for the quick cooking whole grain product are very similar to Minute Rice®.

The barley snack product has been tested as an ingredient in a chocolate cereal snack and in tart and pie fillings. This product is also an alternative to nuts in baking or salads, or for those with allergies to nuts. Furthermore, unlike some other whole grain products, the barley snack product doesn't dry in the mouth.

The end product of micronization differs depending on the cultivar of barley used. For example, the quick cooking product involves micronization of a low amylose barley (for example, CDC Candle) which puffs slightly allowing exposure of endisperm without loss of seed coat or bran layer. As will be appreciated by one of skill in the art, “low amylase” typically refers to a barley cultivar having an amylase content of 0 to about 20%. It is of note that any cultivar which when tempered to 26 to 31% moisture for 18 to 30 hours, heated with infrared heat to 127 to 135 degrees C. and dried to 8 to 13% moisture that produces a resultant product that is slightly puffed and expanded to at least twice its original size is suitable. The texture is pliable not crunchy in the heat treated but uncooked state. The RVA of the product after heat treatment but before cooking is 320 to 342. The RVA after cooking is also available. The TA-XT2 texture for the heat treated and cooked product is approximately 149 kg (3 minutes cooked) which compares to the value for Minute Rice cooked for the recommended cooking time.

The barley snack product is best produced from normal (above 20%, typically about 20 to about 45%) amylose starch types (for example, CDC Dawn and McGwire) which are micronized resulting in a more intact kernel with very slight puffing. In addition, other non waxy types which are commonly used for animal feed may also be used, particularly any other cultivar that when tempered to 27-33% moisture for 18-30 hours and then heated to at least 145-162 degrees C. and then dried to approximately 8 to 13% moisture the resultant grain product has a firm, crunchy, biteable texture similar to “soynuts” or almonds. The interior portion of the grain dissolves quickly in the mouth. The physical texture of the nut product has been measured using instrumental analysis (TA-XT2) to give a force of approximately 7 to 8.1 kg. The chemical nature of the resultant barley nut product can be described as having a peak viscosity of 200 to 320 when tested using a Rapid Visco Analyser (RVA). Lower RVAs result in a too hard kernel texture This data describes the chemical nature of the starch and its degree of gelatinization following processing.

Micronization is an infrared heat process which exposes material to electromagnetic radiation in the wavelength range of 1.8 to 3.4 microns. Food industry applications of micronization include reducing microbial activity, inactivation of enzymes and creating faster cooking products such as quick cook lentils. There are several reasons for micronizing barley. The first relates to the need to inactivate lipolytic enzymes, which cause rancidity, in order to create whole grain or germ containing barley products with acceptable shelf stability. The second reason is related to the positive effect of steam heat treatments on beta-glucan extractability and viscosity, which will result in improved nutritional benefits. There is potential to use this product as a whole grain side dish or in snack foods, granola bars and as an ingredient in bread. In addition, micronization has potential on-farm application for producing value-added grain products.

The whole grain barley product can be prepared without flattening, flaking or pearling of the whole grain barley. The process comprises tempering (moisture added approximately 12 hours prior to heating and shaken repeatedly) raw barley grains to raise internal moisture content to approximately 26 to 30%. Too little moisture will reduce the degree of gelatinization and not produce a crunchy but still biteable nut product or may not produce the correct puffing or product texture. Too much moisture (for example, greater than 35%) would require too much heat to heat up and product may not reach a high enough temperature to gelatinize the starch and puff slightly and result in the best texture. It is of note that in some embodiments, the time of tempering (i.e.: time product sits with added moisture before heat treatment) is also important-too little time the water is not imbibed enough; too much results in germination of the barley.

The tempered barley is then subjected to heat to raise internal temperature to 110 to 134° C., preferably approximately 125° C. and partially gelatinize starch. The temperature of the grain may be measured using an infra red heat gun. The time will vary depending on the machine used and the flow rate, but reaching the required temperature range is important. The barley is then air dried to reach a shelf stable moisture of around 8-13%. It is of note that any suitable method of drying may be employed. Furthermore, it is desired to reduce moisture to a stable level for storage: too much moisture means mold, too little means a hard texture.

The dried whole grain barley product has a negative peroxidase reaction after heating to further ensure shelf stability. The peroxidase test is used to measure any activity of the enzyme peroxidase remaining after heat treatment. This is a fairly heat stable enzyme so if the treatment is enough to inactivate this enzyme we know other enzymes which cause rancidity (such as lipase) will also be inactivated. In whole grain products the germ containing oil (embryo) is still present but so are the degradative enzymes which cause rancidity problems. If the enzymes are controlled it ensures shelf stability of the oil portions in the grain. In addition the heat/moisture treatment results in increased viscosity of soluble fibre components and RVA peak viscosity in the grain compared to untreated grain, as shown in Table 1.

In one embodiment, the quick cooking barley product is heated with infrared heat at a sufficient speed of the assembly belt and slope of the micronizer to achieve a high enough internal grain temperature to allow slight puffing of the kernel without complete distortion of the kernel or without burning the grain. The slightly puffed product holds together, meaning that there is no loss of seed coat or kernel breakage.

We are utilizing pre-tempered barley which is brought up to between 26 to 30% moisture and then heat treated to obtain products with different end use potential depending on physiochemical properties of the specific barley cultivar used. Not all barley cultivars can be used successfully to make these products. Specific starch and hardness characteristics result in varying responses to the treatment. Most barley cultivars tested did not respond successfully to the process. The waxy cultivar CDC Candle was tested because it had a low amylose content (approximately 5%) and produced a slightly puffed product with desirable cooked texture. The outer portion of the slightly puffed product is firm while the center in soft (similar to rice). It is a whole grain product which can cook in less than 5 minutes. It is not a flaked product like rolled oats so it offers potential as a nutritious, whole grain side dish for meals outside the breakfast meal commonly associated with flaked oatmeal products. It has a similar texture to minute rice when cooked for equivalent lengths of time. It has a similar texture to pot or pearled barley but offers whole grain attributes and rapid cook times. It can be used in a number of recipes such as prepared rice dishes, instant soups, puddings and to replace couscous or orzo. Texture and viscosity studies have been done and are shown in Tables 1 and 2.

The uncooked, heat treated product can be used as a nut replacement when served with a number of salted flavourings. This snack is healthful and tasty as well as serving as an alternative for consumers concerned with nut allergies. We have tested it as a baking ingredient as well. It is a crunchy satisfying snack with approximately 6 gram dietary fibre per 35 gram serving.

Barley is high in fiber, beta-glucan, phenolic antioxidants, vitamin E and B-complex vitamins. The nutritional profiles of the processed barley, barley snack product and quick cooking barley product are shown in Tables 3-5 respectively. The nutritional profile provides a number of health benefits including a reduced risk of heart disease, stroke and cancer, plus a boost to the immune system. Furthermore, unlike pearled or pot barley which has had some of the outer nutrient-rich layers of the grain removed, these barley products use the whole barley kernel.

The invention combines ideas of nutrition provided by whole grain barley with lower preparation time and tasty convenient snacks which could act as nut replacements.
1) Development of an instant whole grain, popped/puffed barley product which can be cooked in a similar fashion to “Minute Rice”
2) Development of a whole grain, micronized, flavoured barley snack food which could be considered as a “nut” replacement.
3) Using specific moisture treatments combined with infrared heating (micronization) treatments to achieve a slightly puffed or popped whole grain product which can then be boiled or placed in boiled water and cooked to optimum texture in less than five minutes.
4) Using specific cultivars/varieties of whole grain barley to create a fast cook/instant snack barley product.

While the preferred embodiments of the invention have been described above, it will be recognized and understood that various modifications may be made therein, and the appended claims are intended to cover all such modifications which may fall within the spirit and scope of the invention.

TABLE 1
Properties of Micronized Barley Compared to an Untreated Control

| Temper Level | Peroxidase | Beta-Glucan | RVA Standard Pasting Viscosities (RVU) | | | | | Beta-Glucan AEV |
|---|---|---|---|---|---|---|---|---|
| (%) | Activity | (%, db) | Peak | Hot Paste | Breakdown | Final | Setback | (mPa) |
| Control | Pos | 7.07 | 215 | 107 | 108 | 170 | 63 | 45 |
| 26% | Neg | 7.16 | 339 | 185 | 154 | 271 | 86 | 504 |
| 28% | Neg | 7.03 | 342 | 179 | 163 | 268 | 90 | 463 |
| 30% | Neg | 7.04 | 322 | 158 | 164 | 254 | 97 | 457 |

TABLE 2
Texture of Micronized Barley at Various Cooking Times

| Cook Time | Texture |
|---|---|
| (min) | (kg) |
| 1.0 | 303 |
| 1.5 | 210 |
| 2.0 | 204 |
| 2.5 | 189 |
| 3.0 | 149 |
| Stand Time | Texture |
| (min) | (kg) |
| 2.0 | 256 |
| 4.0 | 219 |
| 6.0 | 188 |

TABLE 3
Comparison of processed and unprocessed barley

| | Before treatment | Processed barley |
|---|---|---|
| Beta-glucan viscosity (mPa) | 45 | 500 |
| RVA peak paste viscosity (RVU) | 215 | 320 |
| Peroxidase activity | positive | negative |

TABLE 4
Approximate nutritional profile of barley snack product

| | In an 18 g serving | | % by weight |
|---|---|---|---|
| Calories | 68.9 | cal | |
| Fat | 0.43 | g | 2.39% |
| Protein | 2.08 | g | 11.57% |
| Total dietary fiber | 2.53 | g | 14.06% |
| Beta-glucan | 0.86 | g | 4.76% |

TABLE 5
Approximate nutritional profile of quick cooking whole
barley product

| | In a prepared ½ cup serving | | % by weight |
|---|---|---|---|
| Calories | 67.5 | cal | |
| Fat | 0.52 | g | 2.89% |
| Protein | 2.26 | g | 12.54% |
| Total dietary fiber | 2.91 | g | 16.15% |
| Beta-glucan | 1.27 | g | 7.07% |

TABLE 6
Ranges for Processing Temperatures, Texture and RVA
Viscosity Measures of Micronized Barley Used as Instant
Product

| | | | RVA | |
|---|---|---|---|---|
| Description of | Processing | | Viscosity (RVU)*** | |
| Cooked Sample | Temp.* | Texture** | Cold Paste | Peak |
| off-white/beige to | 127-135 C. | 126-159 kg/s | 79-142 | 283-325 |
| brown, puffed | | | | |
| appearance mild | | | | |
| nut like flavor, | | | | |
| chewy and soft | | | | |
| Commercial | | 126-151 kg/s | | |
| Minute Rice | | | | |
| (Cooked 3 min) | | | | |

*Represents range in temperatures observed during a given processing run.
**Texture Method for Instant Barley Product cooked for 3-5 min
Area of shear force measured on ˜15 grams of cooked sample using Mini Kramer attachment (TA-91M) on TA-XT2i Texture Analyser
***RVA Cold Paste Method (Raw Sample)
Temperature to 25 C. for first minute, raised to 95 C. over next 3.42 min. held for 3 minutes and lowered to 25 C. over next 3.88 minutes

1. A method of processing barley comprising:
tempering barley grains to 26-30% moisture; and
raising internal temperature of the tempered barley to 110-162° C.

2. The method according to claim 1 wherein the processed barley is air dried to about 12% moisture.

3. The method according to claim 2 wherein the barley grains are low amylose barley.

4. The method according to claim 3 wherein the barley is processed to a quick cooking barley product.

5. The method according to claim 3 wherein the barley is CDC Candle.

6. The method according to claim 2 wherein the barley is normal amylose barley.

7. The method according to claim 6 wherein the barley is processed to a barley snack product.

8. The method according to claim 7 wherein the barley is CDC Dawn.

9. The method according to claim 7 wherein the barley is CDC McGwire.
